(19) United States
(12) Patent Application Publication
(10) Pub. No.: US 2011/0028871 A1
(43) Pub. Date: Feb. 3, 2011

(54) CURVED GUIDE MECHANISM AND WALKING ASSIST DEVICE

(75) Inventor: Makoto Shishido, Saitama (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 12/936,614

(22) PCT Filed: Feb. 6, 2009
(86) PCT No.: PCT/JP2009/000462

§ 371 Date: Oct. 6, 2010

(30) Foreign Application Priority Data
Apr. 7, 2008 (JP) 2008-099144

(51) Int. Cl. A61H 3/00; F16B 7/00

(52) U.S. Cl. 601/34; 403/82

(57) ABSTRACT

A guide track has a circular arc guide groove formed in a guide body. A movable body has two rows of rotating bodies that are separated in the width direction of the guide groove, and each row has a plurality of rotating bodies separated in the longitudinal direction of the guide groove. Each row of the rotating bodies is composed of an inner rotating body in rollable contact with a groove wall surface on the inner peripheral side of the guide groove and an outer rotating body in rollable contact with a groove wall surface on the outer peripheral side of the guide groove. The movable body is provided with thrust receivers making contact, in the groove width direction, with vertical wall sections of the guide body.

### PRIORITY CLAIM

The present application is based on and claims the priority benefit of Japanese Patent Application 2008-099144 filed on Apr. 7, 2008, the contents of which are incorporated herein by reference in its entirety.

### BACKGROUND OF THE INVENTION

1. Field of the Invention

The present invention relates a curved guide mechanism which guides a movable body along a circular arc guide track, and a walking assist device with guide mechanism applied therein.

2. Description of the Related Art

Hitherto, as a walking assist device, there has been known one which is provided with a seat member on which a user sits astride and a leg link supporting the seat member from below, and is configured to support at least a part of user's weight via the seat member by the leg link so as to assist the user in walking by reducing a load applied to the user's leg (for example, refer to Patent Document 1: Japanese Patent Laid-Open No. 2007-20909).

In the device disclosed in Patent Document 1, the seat member and the leg link are connected together via a curved guide mechanism including a guide body which is connected to the seat member and has a circular arc guide track longitudinal in an anteroposterior direction with the center of curvature located above the seat member, and a movable body movably engaged with the guide track via a plurality of rotating bodies. Thereby, the leg link can swing freely in the anteroposterior direction with the center of curvature of a circular arc which is the shape of the guide track serving as a swing fulcrum.

According thereto, in case when the action point of the weight of user's upper body relative to the seat member deviates to the front side of the swing fulcrum in the anteroposterior direction of the leg link and the seat member inclines down to the front side, the swing fulcrum in the anteroposterior direction of the leg link is located above the seat member. Thus, the action point of the weight is shifted rearward below the swing fulcrum in the anteroposterior direction of the leg link, the distance between the swing fulcrum and the action point of the weight in the anteroposterior direction decreases, and a rotation moment applied to the seat member also decreases. The rotation moment applied to the seat member becomes zero when the action point of the weight is shifted right below the swing fulcrum in the anteroposterior direction of the leg link, which makes the seat member stable. As mentioned, since the seat member automatically converges into a stable state thereof, the seat member can be prevented from deviating from the user's hip in the anteroposterior direction.

In the above-mentioned conventional art, a circular arc rail serving as the guide track is fixed to the guide body, and an inner rotating body rotatably engaged with an inner peripheral rail side edge (upper edge) of the rail near the center of curvature of the circular arc and an outer rotating body rotatably engaged with an outer peripheral rail side edge (lower edge) of the rail distant from the center of curvature are provided respectively at front and rear ends of the movable body. Therefore, the width of the movable body in the vertical direction will be equal to or more than the width of the rail in the vertical direction with an addition of the diameters of the inner rotating body and the outer rotating body. As a result, there is a problem such that the movable body becomes large and heavy, and the inertia moment of the leg link increases. Additionally, foreign objects, such as trousers, might be unfavorably squeezed into a space between the side edges of the rail and the rotating bodies engaged therewith to deteriorate the smooth swing of the leg link.

The rotating body is generally constructed from a deep groove ball bearing with the inner ring thereof fit onto the spindle provided in the movable body and the outer ring thereof contacted with the side edges of the rail. In order to make the inner rotating body and the outer rotating body receive the rolling moment in the lateral direction, it is necessary to dispose a groove on the outer peripheral surface of the outer ring for engaging with the side edges of the rail to prevent the outer ring from deviating laterally from the side edges of the rail. Thus, a common deep groove ball bearing without a groove disposed on the outer peripheral surface of the outer ring cannot be adopted as the rotating body. To dispose a groove on the outer peripheral surface of the outer ring will increase manufacture cost.

### SUMMARY OF THE INVENTION

The present invention has been accomplished in view of the aforementioned problems, and it is therefore an object of the present invention to provide a curved guide mechanism at a low cost with a movable body reduced in size and weight and a foreign object prevented from being squeezed therein, and a walking assist device applied with guide mechanism.

To attain an object described above, the curved guide mechanism of the present invention comprises a guide body provided with a circular arc guide track and a movable body movably engaged with the guide track via a plurality of rotating bodies, wherein the guide track is a circular arc guide groove formed in the guide body, the movable body is provided with two rows of rotating bodies separated in the width direction orthogonal to both the longitudinal direction of the guide groove and the direction of the curvature radius of the circular arc, each row of rotating bodies is composed of a plurality of rotating bodies separated in the longitudinal direction of the guide groove, and the plurality of rotating bodies are composed of at least one inner rotating body in rollable contact with a groove wall surface on an inner peripheral side of the guide groove closer to the center of curvature of the circular arc and at least one outer rotating body in rollable contact with a groove wall surface on an outer peripheral side of the guide groove distant from the center of curvature of the circular arc.

The walking assist device of the present invention comprises a seat member on which a user sits astride and a leg link supporting the seat member from below, and the seat member and the leg link being connected together via a curved guide mechanism including a guide body which is connected to the seat member and has a circular arc guide track longitudinal in an anteroposterior direction with the center of curvature located above the seat member, and a movable body which is connected to the upper end of the leg link and is movably engaged with the guide track via a plurality of rotating bodies, wherein the curved guide mechanism of the present invention is used in the walking assist device.

In the curved guide mechanism of the present invention, each row of rotating bodies is provided with the inner rotating body in contact with the groove wall surface on the inner peripheral side of the guide groove and the outer rotating body in contact with the groove wall surface on the outer peripheral side of the guide groove and the inner rotating body and the outer rotating body are separated the longitudinal direction of the guide groove; therefore, the pitching moment (axial moment in the width direction of the guide groove) is subjected to the inner rotating body and the outer rotating body of each row of rotating bodies. Moreover, since two rows of the rotating bodies are disposed with a separation in the width direction of the guide groove, the rolling moment (axial moment in the longitudinal direction of the guide groove) is subjected to the inner rotating body or the outer rotating body of one row of rotating bodies and the outer rotating body or the inner rotating body of the other row of rotating bodies. Thereby, the movable body can be moved smoothly in the guide groove without a play in either the pitching direction or the rolling direction.

By disposing two rows of the rotating bodies to receive the rolling moment, it is not necessary to dispose the engagement groove on the outer peripheral surface of each rotating body for engaging with the guide body. Thereby, a common deep groove ball bearing can be used as the rotating body, and as a result thereof, it is expected to reduce the manufacture cost.

In the curved guide mechanism of the present invention, the inner rotating body and the outer rotating body in each row of rotating bodies are separated in the longitudinal direction of the guide groove; therefore, the inner rotating body and the outer rotating body in each row of rotating bodies can be overlapped in the direction of the curvature radius of the guide groove. Thereby, the width of the guide groove in the direction of the curvature radius can be set equal to the diameter of each rotating body of the inner and outer rotating bodies with a clearance needed to prevent the groove wall surface where the rotating body is contacting with from contacting the groove wall surface on the opposite side. As a result thereof, the width of the guide groove in the direction of the curvature radius can be made smaller, and the movable body can also be made as smaller and lighter as possible.

In the walking assist device applied with the curved guide mechanism of the present invention, since the movable body can be made smaller and lighter, the inertia moment of the leg link can be reduced. Thereby, when the user strokes the leg forward, the resistance caused by the inertia moment of the leg link will become smaller. In addition, since the rotating body is contacting the groove wall surface of the guide groove concaved from the out surface of the guide body, foreign objects such as trousers can be prevented effectively from being squeezed into the contacting portion of the rotating body, providing the leg link to swing smoothly.

In the walking assist device of the present invention, it is desired that the guide body is made of a mold material of a sectional C shape having an inner peripheral wall section constituting the groove wall surface on the inner peripheral side of the guide groove, an outer peripheral wall section constituting the groove wall surface on the outer peripheral side of the guide groove, a pair of vertical wall sections disposed at both sides in the width direction of the guide groove to join the inner peripheral wall section and the outer peripheral wall section, and a slit formed in the middle of the outer peripheral wall section in the width direction of the guide groove to demarcate an inner space for the guide groove, the movable body is provided with an inserting section to be inserted into the guide groove via the slit, and both sides of the inserting section in the width direction of the guide groove is disposed with each row of rotating bodies, respectively. According thereto, foreign objects such as trousers can be prevented from being squeezed into the guide groove, providing the leg link to swing smoothly for certain.

However, in the curved guide mechanism of the present invention, when each row of rotating bodies is formed of one inner rotating body and one outer rotating body, if the sequence of the inner rotating body and the outer rotating body arranged in one row of rotating bodies in the longitudinal direction of the guide groove is the same as the sequence of the inner rotating body and the outer rotating body arranged in the other row of rotating bodies in the longitudinal direction of the guide groove, the inner rotating body and the outer rotating body cannot receive the pitching moment directed away from the groove wall surfaces of the inner peripheral side and the outer peripheral side of the guide groove, respectively. To solve this problem, it is desired that the sequence of the inner rotating body and the outer rotating body arranged in one row of rotating bodies in the longitudinal direction of the guide groove is opposite to the sequence of the inner rotating body and the outer rotating body arranged in the other row of rotating bodies in the longitudinal direction of the guide groove. According thereto, the pitching moment directed away from the groove wall surfaces of the inner peripheral side and the outer peripheral side of the guide groove contacted respectively by the inner rotating body and the outer rotating body in one row of rotating bodies can be received by the other row of rotating bodies, while the pitching moment directed away from the groove wall surfaces of the inner peripheral side and the outer peripheral side of the guide groove contacted respectively by the inner rotating body and the outer rotating body in the other row of rotating bodies can be received by the one row of rotating bodies.

In the curved guide mechanism of the present invention, it is desired that the spindle of one rotating body of the inner rotating body and the outer rotating body is fixed to the movable body, and the spindle of the other rotating body is fixed to a block attached to the movable body via a shim having a thickness in the direction of the curvature radius of the circular arc. According thereto, the spindle of the other rotating body can be adjusted according to the thickness of the shim with respect to the spindle of the one rotating body in the direction of the curvature radius of the circular arc. According thereto, the play of the movable body with respect to the guide groove in the direction of the curvature radius of the circular arc can be easily adjusted through the shim.

In the curved guide mechanism of the present invention, it is desired that the guide body is provided with a vertical wall section joining the groove wall surface on the inner peripheral side of the guide groove and the groove wall surface on the outer peripheral side thereof, and the movable body is provided with a thrust receiver in contact with the vertical wall section in the width direction of the guide groove. According thereto, it is possible to prevent a play from being formed between the movable body and the guide body in the width direction of the guide groove.

### BRIEF DESCRIPTION OF THE DRAWINGS

FIG. 1 is a side view of the walking assist device according to a first embodiment of the present invention.

FIG. 2 is a front view of the walking assist device according to the first embodiment of the present invention.

FIG. 3 is a partially cutaway side view of a curved guide mechanism of the walking assist device according to the first embodiment of the present invention.

FIG. 4 is a perspective view of the curved guide mechanism of the walking assist device according to the first embodiment of the present invention.

FIG. 5 is a cross-sectional view of the curved guide mechanism in FIG. 3 cut along the line V-V.

FIG. 6 is a cross-sectional view of the curved guide mechanism in FIG. 3 cut along the line VI-VI.

FIG. 7 is a perspective view of the curved guide mechanism of the walking assist device according to a second embodiment of the present invention.

FIG. 8 is a cross-sectional view of the curved guide mechanism in FIG. 7 cut along the line VIII-VIII.

FIG. 9 is a cross-sectional view of the curved guide mechanism in FIG. 7 cut along the line IX-IX.

FIG. 10 is a perspective view of the curved guide mechanism of the walking assist device according to a third embodiment of the present invention.

FIG. 11 is a cross-sectional view of the curved guide mechanism in FIG. 10 cut along the line XI-XI.

FIG. 12 is a cross-sectional view of the curved guide mechanism in FIG. 10 cut along the line XII-XII.

### DETAILED DESCRIPTION OF THE PREFERRED EMBODIMENTS

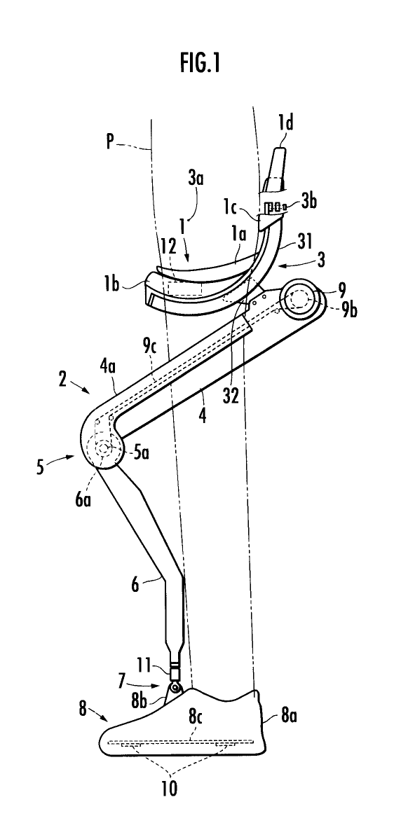

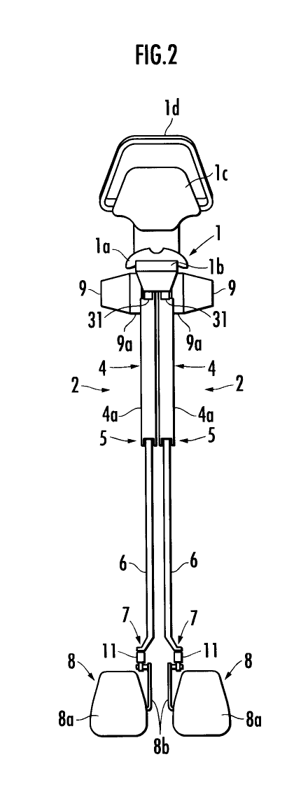

Hereinafter, a walking assist device of an embodiment of the invention will be described. As shown in FIGS. 1 and 2, the walking assist device includes a seat member 1 on which a user P sits astride and a pair of right and left leg links 2 and 2 which support the seat member 1 from below.

Each leg link 2 is a bendable and stretchable link composed of a thigh link 4 connected to the seat member 1 via a curved guide mechanism 3 to be described below so as to be rockable in the anteroposterior direction, and a crus link 6 connected to a lower end of the thigh link 4 via a rotary knee joint 5. Additionally, a foot mounting portion 8 on which one of the right and left feet of the user P is mounted is connected to a lower end of the crus link 6 via an ankle joint 7.

Additionally, each leg link 2 is loaded with a drive source 9 for driving the knee joint 5. The drive source 9 drives the knee joint 5 to apply a force to each leg link 2 in the stretching direction so as to generate a supporting force (hereinafter referred to a body weight relieving assist force) which supports at least a portion of the weight of the user P. The body weight relieving assist force generated in each leg link 2 is transmitted to the body of the user P via the seat member 1, and the load applied to the legs of the user P is alleviated.

The drive source 9 is constituted by an electric motor provided with a speed reducer 9a fixed on an outer side surface of an upper end portion of the thigh link 4. A driving pulley 9b serving as an output member of the speed reducer 9a and a driven pulley 6a fixed to the crus link 6 coaxially with a joint shaft 5a of the knee joint 5 are connected together via a wrapping transmission member 9c, such as a wire, a chain or a belt. According thereto, the power output from the drive source 9 via the speed reducer 9a is transmitted to the crus link 6 via the wrapping transmission member 9c to swing the crus link 6 around the joint shaft 5a relative to the thigh link 4 so as to bend or stretch the leg link 2. In addition, the thigh link 4 is provided with a cover 4a for covering the wrapping transmission member 9c.

The seat member 1 s composed of a seat portion 1a, a support frame 1b, and a waist supporter 1c. The seat portion 1a is of a saddle shape to be seated by the user P. The support frame 1b is disposed below the seat portion 1a to support the seat portion 1a. The support frame 1b is configured to extend upward behind the seat portion 1a to form an uprising portion at a rear end thereof. The waist supporter 1c is disposed at the uprising portion. A holding portion 1d of an arch shape is disposed in the waist supporter 1c for being held by the user P.

Each foot mounting portion 8 is provided with a shoe 8a, and a connection member 8b which is fixed to the shoe 8a and extends upward. Also, the crus link 6 of each leg link 2 is connected to the connection member 8b via the ankle joint 7 of a 3-axis structure. As illustrated in FIG. 1, a pair of front and rear pressure sensors 10, 10 configured to detect the load acted on a middle interphalangeal joint (MP joint) and a heel of the foot of the user P are attached to the undersurface of an insole 8c provided in the shoe 8a. Furthermore, a 2-axis force sensor 11 is assembled in the ankle joint 7. Detection signals of the pressure sensor 10 and the force sensor 11 are inputted to a controller 12 housed in the support frame 1b of the seat member 1. On the basis of the signals from the pressure sensor 10 and the force sensor 11, the controller 12 controls the drive source 9 to drive the knee joint 5 of the leg link 2, and executes a walking assist control to generate the body weight relieving assist force.

The body weight relieving assist force, when viewed in the lateral direction, is acted on a connection line (hereinafter, referred to as a reference line) joining a swing fulcrum 3a of the leg link 2 with respect to the seat member 1 in the anteroposterior direction and a swing fulcrum of the leg link 2 with respect to the ankle joint 7 in the anteroposterior direction. In the walking assist control, the actual body weight relieving assist force acted on the reference line (accurately, a resultant force between the body weight relieving assist force and a force generated by the self weight of the seat member 1 and each leg link 2) is calculated based on the detection force in the biaxial direction detected by the force sensor 11. Thereafter, on the basis of the pressure detected by the pressure sensors 10 in each foot mounting portion 8, a ratio of the load acted on each foot with respect to the total load acted on both feet of the user P is calculated. Then, a desired control value of the body weight relieving assist force which should be generated for each leg link 2 is calculated by multiplying a predefined value of the body weight relieving assist force by the calculated ratio of the load acted on each foot. Subsequently, the drive source 9 is controlled to approximate the actual body weight relieving assist force calculated on the basis of the detection force by the force sensor 11 to the desired control value.

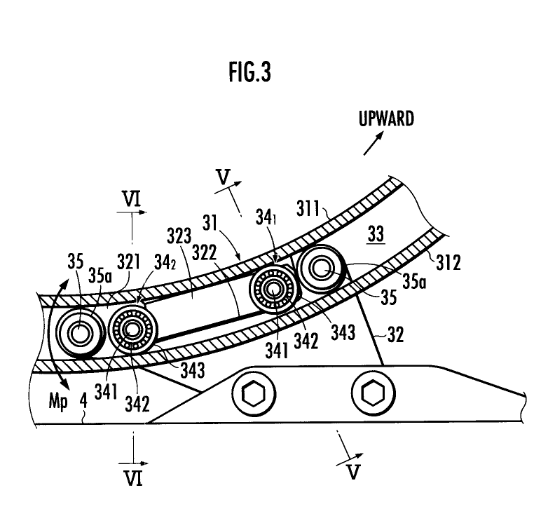

The curved guide mechanism 3 is composed of a guide body 31 connected to the rising portion of the rear end of the support frame 1b of the seating member 1 via a spindle 3b disposed in the anteroposterior direction so as to be rockable in the lateral direction, and a movable body 32 fixed to an upper end portion of the thigh link 4. With reference to FIG. 3, the guide body 31 is formed with a circular arc guide groove 33 which is long in the anteroposterior direction and serves as a guide track. The center of curvature 3a of the circular arc guide groove 33 is located above the seat portion 1a of the seating member 1.

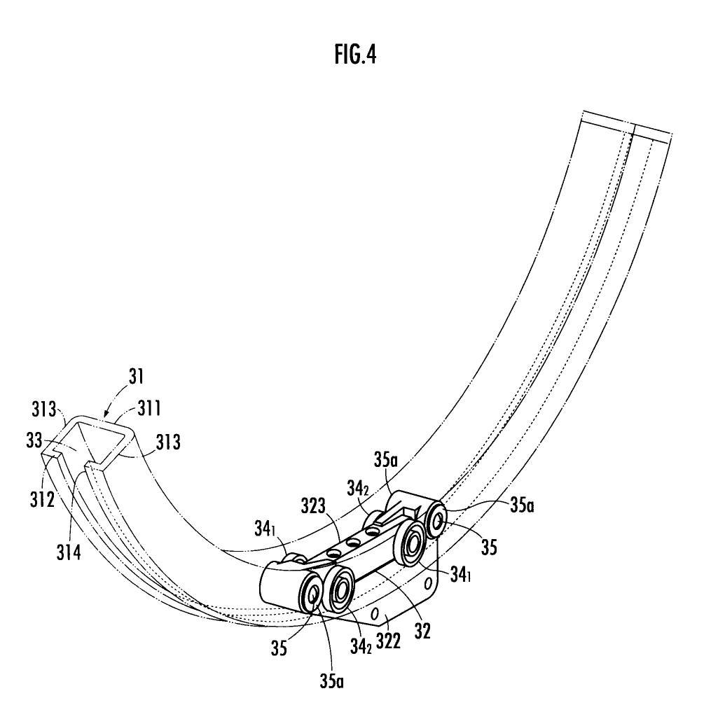

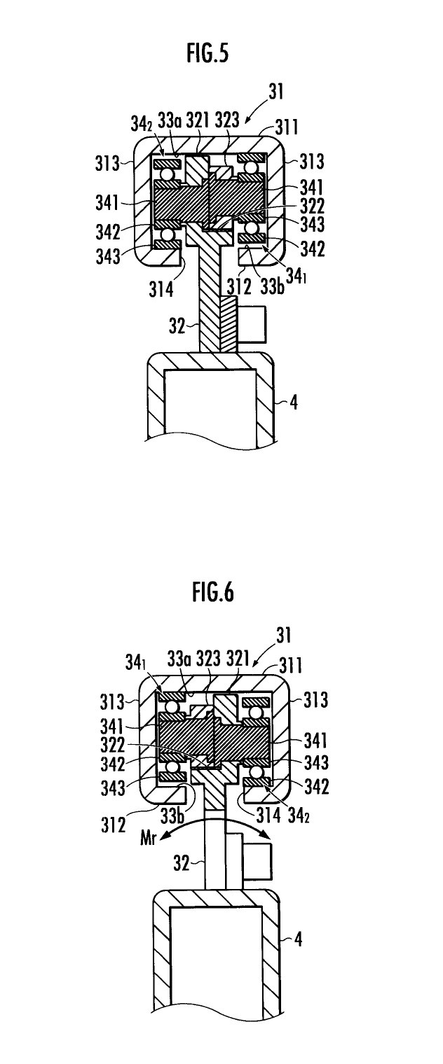

Hereinafter, descriptions will be carried out on the curved guide mechanism 3 with reference to FIG. 3 through FIG. 6.

The guide body 31 is made of a mold material of a sectional C shape having an inner peripheral wall section 311 constituting a groove wall surface 33a on the inner peripheral side of the guide groove 33 close to the center of curvature 3a, an outer peripheral wall section 312 constituting a groove wall surface 33b on the outer peripheral side of the guide groove 33 far away from the center of curvature 3a, a pair of vertical wall sections 313 and 313 disposed at both sides in the the width direction (lateral direction) of the guide groove orthogonal to both the longitudinal direction (anteroposterior direction) of the guide groove 33 and the direction of the curvature radius of the circular arc (vertical direction) to join the inner peripheral wall section 311 and the outer peripheral wall section 312, and a slit 314 formed in the middle of the outer peripheral wall section 312 in the width direction of the guide groove. The guide groove 33 is demarcated by the inner space of the mold material. In FIG. 4, the leg link 2 is omitted.

The movable body 32 is provided with an insertion section 321 to be inserted into the guide groove 33 through the slit 314 disposed in the guide body 31. The insertion section 321 is disposed with one row of rotating bodies. The one row of rotating bodies is comprised of one inner rotating body 34₁ and one outer rotating body 34₂ disposed with a separation in the longitudinal direction of the guide groove 33 on both sides of the insertion section 321 in the width direction of the guide groove, respectively. Thus, the movable body 32 is disposed with two rows of rotating bodies separated in the width direction of the guide groove.

The inner rotating body 34₁ is in rollable contact with the groove wall surface 33a on the inner peripheral side of the guide groove 33. The outer rotating body 34₂ is in rollable contact with the groove wall surface 33b on the outer peripheral side of the guide groove 33. Each of the rotating bodies 34₁ and 34₂ is constructed from a deep groove ball bearing. The inner ring 342 of the ball bearing is fit onto a spindle 341 provided in the insertion section 321 of the movable body 32; and the outer ring 343 of the ball bearing is in contact with the groove wall surface 33a on the inner peripheral side of the guide groove 33 and the groove wall surface 33b on the outer peripheral side of the guide groove 33.

According thereto, the inner rotating body 34₁ and the outer rotating body 34₂ in each row of rotating bodies are separated in the longitudinal direction of the guide groove 33, and the inner rotating body 34₁ is in contact with the groove wall surface 33a on the inner peripheral side of the guide groove 33 and the outer rotating body 34₂ is in contact with the groove wall surface 33b on the outer peripheral side of the guide groove 33; therefore, the pitching moment (axial moment in the width direction of the guide groove) Mp is subjected to the inner rotating body 34₁ and the outer rotating body 34₂ in each row of rotating bodies.

However, if the sequence of the inner rotating body 34₁ and the outer rotating body 34₂ arranged in one row of rotating bodies in the longitudinal direction of the guide groove 33 is the same as the sequence of the inner rotating body 34₁ and the outer rotating body 34₂ arranged in the other row of rotating bodies in the longitudinal direction of the guide groove 33, the inner rotating body 34₁ and the outer rotating body 34₂ cannot receive the pitching moment directed away from the groove wall surfaces 33a and 33b on the inner peripheral side and the outer peripheral side of the guide groove 33, respectively.

To solve this problem, in the present embodiment, the sequence of the inner rotating body 34₁ and the outer rotating body 34₂ arranged in one row of rotating bodies in the longitudinal direction of the guide groove 33 is configured opposite to the sequence of the inner rotating body 34₁ and the outer rotating body 34₂ arranged in the other row of rotating bodies in the longitudinal direction of the guide groove 33.

According thereto, the pitching moment directed away from the groove wall surfaces 33a and 33b on the inner peripheral side and the outer peripheral side of the guide groove 33 contacted respectively by the inner rotating body 34₁ and the outer rotating body 34₂ in one row of rotating bodies can be received by the other row of rotating bodies, while the pitching moment directed away from the groove wall surfaces 33a and 33b on the inner peripheral side and the outer peripheral side of the guide groove 33 contacted respectively by the inner rotating body 34₁ and the outer rotating body 34₂ in the other row of rotating bodies can be received by the one row of rotating bodies.

Further, since two rows of the rotating bodies are disposed with a separation in the width direction of the guide groove 33, the rolling moment (axial moment in the longitudinal direction of the guide groove 33) Mr is subjected to the inner rotating body 34₁ or the outer rotating body 34₂ in one row of rotating bodies and the outer rotating body 34₂ or the inner rotating body 34₁ of the other row of rotating bodies. Thereby, the movable body 32 can move smoothly in the guide groove 33 without a play in either the pitching direction or the rolling direction. Thereby, each leg link 2 swings in the anteroposterior direction around the center of curvature 3a of the guide groove 33, and consequently, the swing fulcrum in the anteroposterior direction of each leg link 2 relative to the seat member 1 becomes the center of curvature 3a of the guide groove 33.

As mentioned above, since the guide body 31 is rockably connected to the seat member 1 in the lateral direction via the spindle 3b, it is possible to abduct the leg of the user P. In the present embodiment, the center of curvature 3a (swing fulcrum in the anteroposterior direction of the leg link 2) of the guide groove 33 and the axial line of the spindle 3b are located above the seat portion 1a. Therefore, the seat member 1 can be prevented from tilting greatly from laterally or vertically when the weight of the user P is shifted.

Two rows of rotating bodies are disposed with a separation in the width of the guide groove to accept the rolling moment Mr, therefore, it is not necessary to form an engagement groove on the outer peripheral surface of the outer ring 343 of the ball bearing constituting each of the rotating bodies 34₁ and 34₂ for engaging with the guide body 31. Thereby, a common deep groove ball bearing can be used as the rotating body 34₁ or 34₂, and as a result thereof, it is expected to cut down the manufacture cost.

The insertion section 321 of the movable body 32 is disposed with a block 323 via a shim 322. The shim 322 has a thickness in the direction of the curvature radius of the circular arc of the guide groove 33. The spindle 341 of the outer rotating body 34₂ in each row of rotating bodies is fixed to the insertion section 321, and the spindle 341 of the inner rotating body 34₁ in each row of rotating bodies is fixed to the block 323. According thereto, the spindle 341 of the inner rotating body 34₁ can displace with respect to the spindle 341 of the outer rotating body 34₂ in the direction of the curvature radius of the circular arc of the guide groove 33 according to the thickness of the shim 322. Thereby, the play of the movable body 32 with respect to the guide groove 33 in the in the direction of the curvature radius of the circular arc can be easily adjusted through the shim 322.

The inner rotating body 34₁ and the outer rotating body 34₂ in each row of rotating bodies are separated in the longitudinal direction of the guide groove 33; therefore, the inner rotating body 34₁ and the outer rotating body 34₂ in each row of rotating bodies can be overlapped in the direction of the curvature radius (vertical direction) of the guide groove 33. Thereby, the width of the guide groove 33 in the vertical direction can be set equal to the each diameter of the inner rotating body 34₁ and the outer rotating body 34₂ with a clearance needed to prevent the groove wall surface where the rotating body is contacting with from contacting the groove wall surface on the opposite side. As a result thereof, the width of the guide groove 33 in the vertical direction can be made smaller, and consequently, the movable body 32 can also be made as smaller and lighter as possible. Thus, the inertia moment of the leg link 2 can be reduced, and the resistance caused by the inertia moment of the leg link 2 can be smaller when the user P strokes the leg forward.

Furthermore, the guide body 31 is constructed from a mold material of a sectional C shape. According thereto, foreign objects such as trousers can be prevented from entering the guide groove 33 for certain. Thus, foreign objects cannot be squeezed into the contacting portions of the rotating bodies 34₁ and 34₂, providing the leg link to swing smoothly for certain.

The insertion section 321 of the movable body 32 is provided with a thrust receiver 35, namely a ball which is disposed at both end portions thereof in the longitudinal direction of the guide groove 33 and is configured to have contact with each vertical wall section 313 of the guide body 31 in the width direction of the guide groove, which prevents a play from being formed between the movable body 32 and the guide body 31 in the width direction of the guide groove, and receives the yawing moment (axial moment in the direction of the curvature radius of the guide groove 33). In addition, the reference numeral 35a is a cap disposed to prevent the ball serving as the thrust receiver 35 from dropping out.

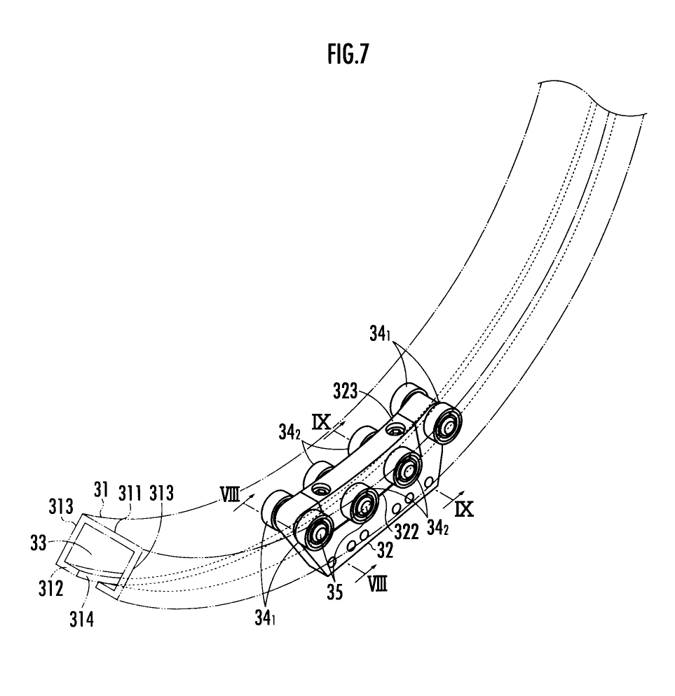

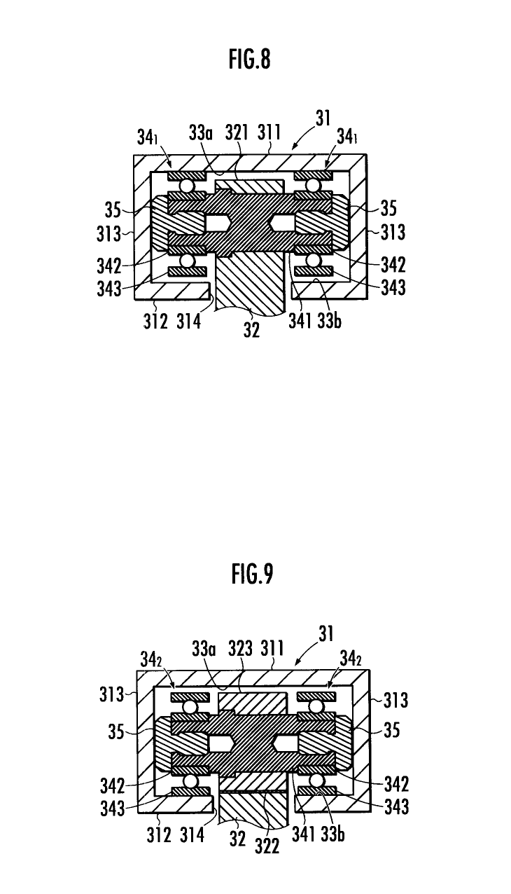

In the first embodiment, each row of rotating bodies is configured to have two rotating bodies with one inner rotating body 34₁ and one outer rotating body 34₂; however, it is not limited thereto. For example, it is acceptable for each row of rotating bodies to include three rotating bodies with either side of the inner rotating body 34₁ and the outer rotating body 34₂ to have one rotating body and the other side to have two rotating bodies. Furthermore, as illustrated from FIG. 7 to FIG. 9 in a second embodiment, it is acceptable for each row of rotating bodies to have two inner rotating bodies 34₁ and two outer rotating bodies 34₂. Thus, by configuring each row of rotating bodies to have three or more rotating bodies, the pitching moment in either direction can be received by the inner rotating body 34₁ and the outer rotating body 34₂ in each row of rotating bodies. Thereby, in the second embodiment, the sequence of the inner rotating body 34₁ and the outer rotating body 34₂ arranged in one row of rotating bodies in the longitudinal direction of the guide groove 33 is configured identical to the sequence of the inner rotating body 34₁ and the outer rotating body 34₂ arranged in the other row of rotating bodies in the longitudinal direction of the guide groove 33. Specifically, two inner rotating bodies 34₁ in each row of rotating bodies are disposed at both ends of the insertion section 321 of the movable body 32 in the longitudinal direction of the guide groove 33 and the other two outer rotating bodies 34₂ in each row of rotating bodies are disposed in the middle of the insertion section 321.

The spindle 341 of the inner rotating body 34₁ in each row of rotating bodies is fixed to the insertion section 321 of the movable body 32, and the spindle 341 of the outer rotating body 34₁ in each row of rotating bodies is fixed to the block 323 through the shim 322. Further, the thrust receiver 35 which is configured to have contact with each vertical wall section 313 of the guide body 31 in the width direction of the guide groove is fixed to the spindle 341 of each of the rotating bodies 34₁ and 34₂. Specifically, the thrust receiver 35 is fixed indirectly to the movable body 32 via the spindle 341. The thrust receiver 35 in the present embodiment is of a slide type.

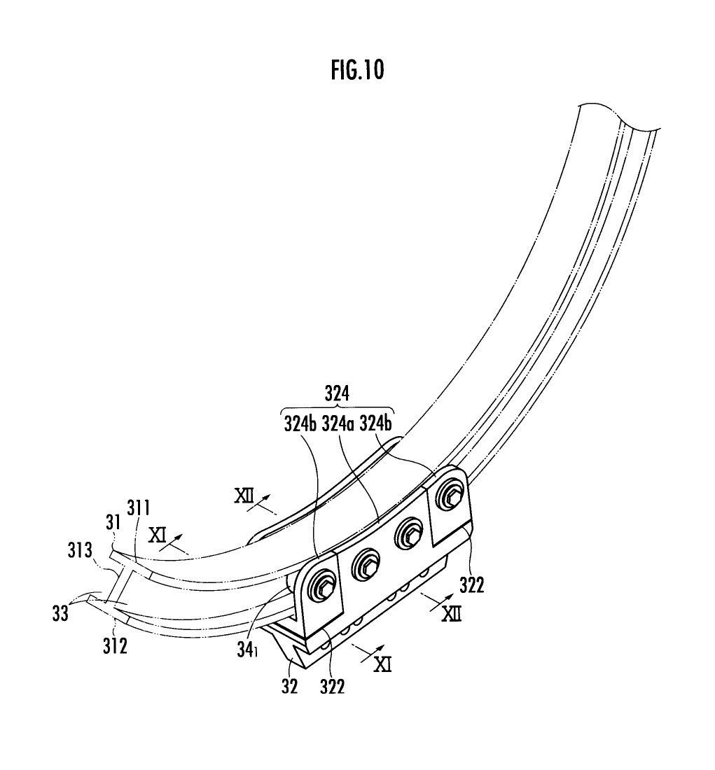

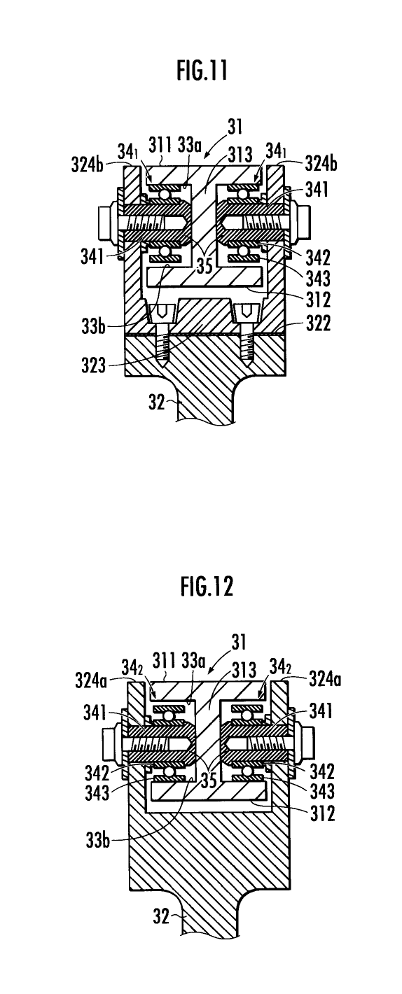

In the first and second embodiments mentioned above, the guide body 31 is configured to be a mold material of a sectional C shape; however, it is not limited thereto. For example, as illustrated from FIG. 10 to FIG. 12 in a third embodiment, it is acceptable that the guide body 31 is made of a mold material of a sectional H shape having an inner wall section 311 constituting a groove wall surface 33a on the inner peripheral side of the guide groove 33, an outer wall section 312 constituting a groove wall surface 33b on the outer peripheral side of the guide groove 33, and a vertical wall section 313 joining the inner wall section 311 and the outer wall section 312 in the middle of the groove width. Thereby, the vertical wall section 313 partitions a pair of guiding grooves 33 between the inner wall section 311 and the outer wall section 312.

The movable body 32 in the third embodiment is provided with a pair of side plate sections 324 sandwiching the guide body 31 in the groove width. Each row of rotating bodies formed by two inner rotating bodies 34₁ and two outer rotating bodies 34₂ is disposed at the inner side of each side plate section 324 in the groove width direction. Each plate section 324 is provided with a portion 324a integral to the movable body 32, a portion 324b integral to the block 323 fixed to the movable body 32 via the shim 322. The spindle 341 of the outer rotating body 34₂ is fixed via a bolt to the portion 324a of the side plate section 324 integral to the movable body 32, and the spindle 341 of the inner rotating body 34₁ is fixed via a bolt to the portion 324b of the side plate section 324 integral to the block 323. The thrust receiver 35 of a slide type is molded integrally at the end portion of each spindle 341. The thrust receiver 35 is configured to have contact with the vertical wall section 313 in the groove width.

According to the curved guide mechanism 3 in the third embodiment, since the rotating bodies 34₁ and 34₂ have contact with the groove wall surfaces 33a and 33b of the guide groove 33 concaved in the outer side of the guide body 31, foreign objects such as trousers or the like can be inhibited from being squeezed into the contacting portions of the rotating bodies 34₁ and 34₂. However, it is preferable for the guide body 31 to be made of a mold material of a sectional C shape, which can prevent foreign objects from entering the guide groove 33 for certain.

The embodiments of the present invention have been described in the above with reference to the drawings; however, the present invention is not limited thereto. For example, in the above-mentioned embodiments, the leg link 2 is configured to be a bendable and stretchable link having a rotary joint 5 in the middle; however, it is acceptable to configure it as a telescopic link having a linear joint in the middle. It is also acceptable to omit the foot mounting portion 8. In this case, the lower end portion of each leg link 2 is fixed to the crus of each leg of the user through an appropriate fixing portion, and the leg portion below the fixing portion is used as a reaction force receiver to generate a body weight relieving assist force. Furthermore, in order to assist the walking of a handicapped user whose one leg is crippled due to bone fracture or the like, it is possible to leave only one leg link of the left and right leg links 2 and 2 in the above-mentioned embodiment corresponded to the crippled leg of the user by removing the other. Additionally, it is also possible to provide a biasing member to bias the knee joint 5 in the stretching direction (in the direction of pushing the seat member 1 upward) so as to omit the drive source 9.

In the embodiments mentioned above, the curved guide mechanism 3 is applied in the walking assist device; however, it is not limited thereto. The curved guide mechanism of the present invention can be used in a device other than the walking assist device.

1. A curved guide mechanism comprising a guide body provided with a circular arc guide track and a movable body movably engaged with the guide track via a plurality of rotating bodies,
wherein
the guide track is a circular arc guide groove disposed in the guide body,
the movable body is provided with two rows of rotating bodies separated in the width direction of the guide groove orthogonal to both the longitudinal direction thereof and the direction of the curvature radius of the circular arc,
each row of rotating bodies is composed of a plurality of rotating bodies separated in the longitudinal direction of the guide groove, and
the plurality of rotating bodies are composed of at least one inner rotating body in rollable contact with a groove wall surface on an inner peripheral side of the guide groove closer to the center of curvature of the circular arc and at least one outer rotating body in rollable contact with a groove wall surface on an outer peripheral side of the guide groove distant from the center of curvature of the circular arc.

2. The curved guide mechanism according to claim 1, wherein each row of rotating bodies is comprised of one inner rotating body and one outer rotating body, and
the sequence of the inner rotating body and the outer rotating body arranged in one row of rotating bodies in the longitudinal direction of the guide groove is opposite to the sequence of the inner rotating body and the outer rotating body arranged in the other row of rotating bodies in the longitudinal direction of the guide groove.

3. The curved guide mechanism according to claim 1, wherein
a spindle of one rotating body of the inner rotating body and the outer rotating body is fixed to the movable body, and
a spindle of the other rotating body is fixed to a block attached to the movable body via a shim having a thickness in the direction of the curvature radius of the circular arc.

4. The curved guide mechanism according to claim 1, wherein
the guide body is provided with a vertical wall section joining the groove wall surface on the inner peripheral side of the guide groove and the groove wall surface on the outer peripheral side thereof, and
the movable body is provided with a thrust receiver in contact with the vertical wall section in the width direction of the guide groove.

5. A walking assist device comprising a seat member on which a user sits astride and a leg link supporting the seat member from below, and the seat member and the leg link being connected together via a curved guide mechanism including a guide body which is connected to the seat member and has a circular arc guide track longitudinal in an anteroposterior direction with the center of curvature located above the seat member, and a movable body which is connected to the upper end of the leg link and is movably engaged with the guide track via a plurality of rotating bodies, wherein the guide mechanism is the one according to claim 1.

6. The walking assist device according to claim 5, wherein
the guide body is made of a mold material of a sectional C shape having an inner peripheral wall section constituting the groove wall surface on the inner peripheral side of the guide groove, an outer peripheral wall section constituting the groove wall surface on the outer peripheral side of the guide groove, a pair of vertical wall sections disposed at both sides in the width direction of the guide groove to join the inner peripheral wall section and the outer peripheral wall section, and a slit formed in the middle of the outer peripheral wall section in the width direction of the guide groove to demarcate an inner space for the guide groove,
the movable body is provided with an inserting section to be inserted into the guide groove via the slit, and
both sides of the inserting section in the width direction of the guide groove is disposed with each row of rotating bodies, respectively.

7. The curved guide mechanism according to claim 2, wherein
a spindle of one rotating body of the inner rotating body and the outer rotating body is fixed to the movable body, and
a spindle of the other rotating body is fixed to a block attached to the movable body via a shim having a thickness in the direction of the curvature radius of the circular arc.

8. The curved guide mechanism according to claim 2, wherein
the guide body is provided with a vertical wall section joining the groove wall surface on the inner peripheral side of the guide groove and the groove wall surface on the outer peripheral side thereof, and
the movable body is provided with a thrust receiver in contact with the vertical wall section in the width direction of the guide groove.

9. The curved guide mechanism according to claim 3, wherein
the guide body is provided with a vertical wall section joining the groove wall surface on the inner peripheral side of the guide groove and the groove wall surface on the outer peripheral side thereof, and
the movable body is provided with a thrust receiver in contact with the vertical wall section in the width direction of the guide groove.

10. A walking assist device comprising a seat member on which a user sits astride and a leg link supporting the seat member from below, and the seat member and the leg link being connected together via a curved guide mechanism including a guide body which is connected to the seat member and has a circular arc guide track longitudinal in an anteroposterior direction with the center of curvature located above the seat member, and a movable body which is connected to the upper end of the leg link and is movably engaged with the guide track via a plurality of rotating bodies, wherein the guide mechanism is the one according to claim 2.

11. The walking assist device according to claim 10, wherein
the guide body is made of a mold material of a sectional C shape having an inner peripheral wall section constituting the groove wall surface on the inner peripheral side of the guide groove, an outer peripheral wall section constituting the groove wall surface on the outer peripheral side of the guide groove, a pair of vertical wall sections disposed at both sides in the width direction of the guide groove to join the inner peripheral wall section and the outer peripheral wall section, and a slit formed in the middle of the outer peripheral wall section in the width direction of the guide groove to demarcate an inner space for the guide groove,
the movable body is provided with an inserting section to be inserted into the guide groove via the slit, and
both sides of the inserting section in the width direction of the guide groove is disposed with each row of rotating bodies, respectively.

12. A walking assist device comprising a seat member on which a user sits astride and a leg link supporting the seat member from below, and the seat member and the leg link being connected together via a curved guide mechanism including a guide body which is connected to the seat member and has a circular arc guide track longitudinal in an anteroposterior direction with the center of curvature located above the seat member, and a movable body which is connected to the upper end of the leg link and is movably engaged with the guide track via a plurality of rotating bodies, wherein the guide mechanism is the one according to claim 3.

13. The walking assist device according to claim 12, wherein
the guide body is made of a mold material of a sectional C shape having an inner peripheral wall section constituting the groove wall surface on the inner peripheral side of the guide groove, an outer peripheral wall section constituting the groove wall surface on the outer peripheral side of the guide groove, a pair of vertical wall sections disposed at both sides in the width direction of the guide groove to join the inner peripheral wall section and the outer peripheral wall section, and a slit formed in the middle of the outer peripheral wall section in the width direction of the guide groove to demarcate an inner space for the guide groove,
the movable body is provided with an inserting section to be inserted into the guide groove via the slit, and
both sides of the inserting section in the width direction of the guide groove is disposed with each row of rotating bodies, respectively.

14. A walking assist device comprising a seat member on which a user sits astride and a leg link supporting the seat member from below, and the seat member and the leg link being connected together via a curved guide mechanism including a guide body which is connected to the seat member and has a circular arc guide track longitudinal in an anteroposterior direction with the center of curvature located above the seat member, and a movable body which is connected to the upper end of the leg link and is movably engaged with the guide track via a plurality of rotating bodies, wherein the guide mechanism is the one according to claim 4.

15. The walking assist device according to claim 14, wherein
the guide body is made of a mold material of a sectional C shape having an inner peripheral wall section constituting the groove wall surface on the inner peripheral side of the guide groove, an outer peripheral wall section constituting the groove wall surface on the outer peripheral side of the guide groove, a pair of vertical wall sections disposed at both sides in the width direction of the guide groove to join the inner peripheral wall section and the outer peripheral wall section, and a slit formed in the middle of the outer peripheral wall section in the width direction of the guide groove to demarcate an inner space for the guide groove,
the movable body is provided with an inserting section to be inserted into the guide groove via the slit, and
both sides of the inserting section in the width direction of the guide groove is disposed with each row of rotating bodies, respectively.
